(19) United States
(12) Patent Application Publication
(10) Pub. No.: US 2019/0385193 A1
(43) Pub. Date: Dec. 19, 2019

(54) REAL TIME ADVERTISEMENT SYSTEM

(71) Applicant: DIGICITY TECHNOLOGIES BILISIM MEDYA TEKNOLOJI DANISMANLIK LTD. STI., Istanbul (TR)

(72) Inventor: TACETTIN TIRAS, ISTANBUL (TR)

(21) Appl. No.: 16/011,607

(22) Filed: Jun. 18, 2018

(51) Int. Cl. G06Q 30/02; G06F 3/16; G09F 19/00

(52) U.S. Cl. CPC G06Q 30/0261; G06K 2009/00322; G09F 19/00; G06F 3/167

(57) ABSTRACT

An advertising assembly (1) having a display (2) on which advertisement broadcasts are made, with its sensors (3) detecting the person in front of the advertisement system, the camera (4) capturing the image of the person, the microphone (6) receiving the voice and a computer assembly (5) which evaluates the transmitted data from the camera and microphone and reflects the figure matching the result of the evaluation on the display (2).

### TECHNICAL FIELD

This disclosure relates to a real-time advertising system in the information advertising and advertisement industries in a real-time location with a camera system operating on any screen, such as a screen with/without a mirror, led billboard and kiosk, designed to be placed in indoor and outdoor public areas.

### BACKGROUND

For the Turkish utility model application no. 2008/01598, the invention relates to an illuminated, multi-purpose mirror assembly which is positioned indoors and outdoors and which can function both as a billboard and a mirror used as a reflective surface for images. Said mirror assembly consists of an outer frame, a mirror positioned within said outer frame, at least one sensor positioned on said outer frame capable of sensing movements performed within the sensing distance, at least one advertising surface positioned at the rear of said mirror, providing advertisements and promotions, at least one illumination component positioned on said mirror assembly and flashing depending on the sensing of movement performed within the sensing distance of the sensor.

In the known technique, when the sensors included in the reflective mirror move within the sensing range, the electrical connections of the lighting elements are cut off and the mirror assembly looks mirror-like as the illumination components are turned off. If there is no motion within the sensing range, the lighting elements operate and emit light, so that the advertising surface is visible on the mirror assembly and becomes an advertisement billboard.

In the aforementioned mirror screens, the mirror sensor continuously displays during the time when it cannot detect an object passing in front of it, but when the sensor detects one, the display stops. Therefore, this technique causes a waste of energy when nobody passes by and sees the advertisement. When the mirror is approached, the person-sensing system stops the advert and broadcasting cannot be performed.

Another technical problem is not displaying the ad to the target person, therefore deviating from the purpose of the ad. It is not possible to make sure that the ads displayed with this technique are visible to the target audience or other people.

In different known techniques, digital signage, that is, digital information systems, screens and mirrors, which can manage hundreds of digital displays connected to the server from single point thanks to special software, are used in public areas. In such systems it is possible to intercept all digital screens via a server and send images to the screens instantly by intervention. However, in these systems, there is no infrastructure capable of detecting the target audience and broadcasting to the target audience.

### SUMMARY

In the state of the art, the system described in embodiments of in the invention is created with the aim of overcoming the above-mentioned problems.

With embodiments of the invention, the image of the person in front of the screen is captured and transferred to a software-based system and the system analyzes the person and starts broadcasting by selecting the appropriate advertisement. Thus, the ad will reach its target audience.

Unlike other products used in other public areas, the mirror-form advertisement media used in the system of embodiments of the invention can be kept in the mind of the consumer and create a surprise effect by providing an individual communication with the target audience.

In the case of some embodiments of the invention, for example, a toilet mirror becomes a PC screen of a person for a short period of time. On this screen, when the person's face is not blocked and the person goes in front of the mirror, the ads will be broadcast on part of the mirror rather than its entirety before the screen is turned off. The person interacts with the advertisement displayed on one side of the mirror while looking at his/her reflection on the mirror. So the main aim of looking at the mirror is not blocked.

The system of the invention consists in some embodiments of the following parts:
a. Screen hidden behind the mirror to show ads
b. Connected computers and devices to allow advertisements to be displayed on screens,
c. A sensor, which senses persons passing by and commands the operating system,
d. At least one camera arrangement that takes images of the person to transmit the images to the system for analysis of at least one of parameters such as mood, gender, age, facial lines, hair color etc. of the person passing by the screen,
e. Decorative LED lights.

The mirror to be used in embodiments of the invention may be any type of mirror, semi-permeable, filtered, or from 2 mm up to 20 mm, or bullet-proof, bendable flexible type or may include reflective coatings on glass. The mirrored display can be in the form of LCD, LED, projection, plasma, hologram and other varieties.

The mirror in some embodiments of the present invention includes a sensor and a camera sensor which can detect the persons in front of the screen and give commands to the operating system, and it has a computer system connected to the sensor and the camera for displaying the advertisements on the screens.

As soon as someone approaches the mirror, the sensor detects the person, the system starts, the image of the person is captured by the camera and transmitted to the system, the system selects the appropriate one from the media loaded online in system memory and displays it to the person. With the appropriate ad selection, the ad reaches the target audience.

Mirrors with displays are placed free of charge in public areas such as subway stations, shopping centers, airports, bus terminals, public toilets, lifts, hotel lobbies, barbers and hairdressers, pharmacies, universities and all kinds of schools, residential areas, buildings, sports halls, so that a highly widespread network can be achieved quickly.

### BRIEF DESCRIPTION OF THE FIGURES

FIG. 1: General appearance of the mirror with camera display according to an embodiment of the invention

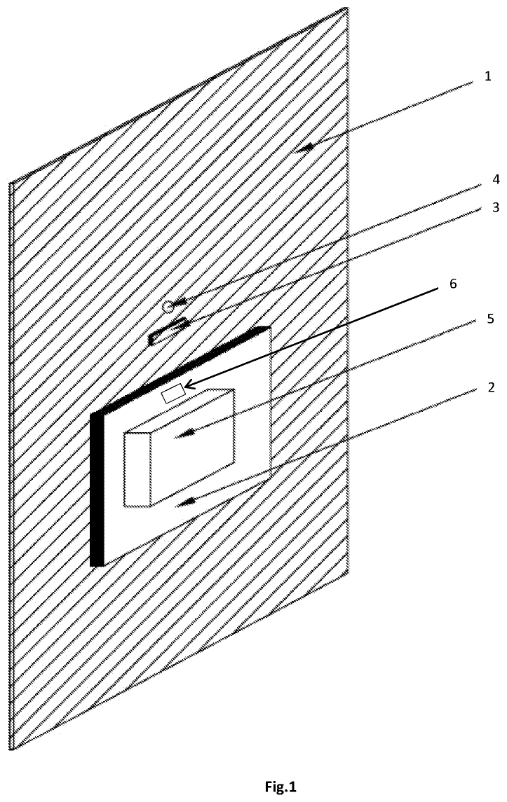

FIG. 2: Cross section appearance of the mirror with camera display according to an embodiment of the invention

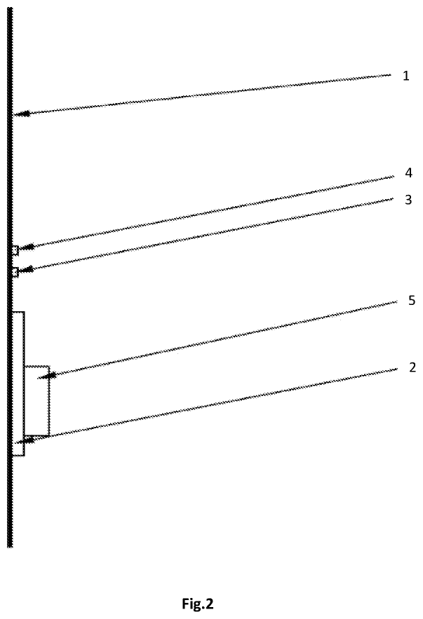

### REFERENCE NUMBERS

1. Advertisement assembly
2. Display
3. Sensor
4. Camera
5. Computer assembly
6. Microphone

### DETAILED DESCRIPTION

The invention in embodiments is related to a real-time advertisement system comprised of an advertisement assembly (1) which houses a computer assembly (5) having a display (2), a sensor (3), a camera (4), a microphone (6) software, an operating system, database, etc. Said advertising assembly (1) may be with/without a mirror or may be selected from any type of screen such as LED billboard and kiosk.

The invention in some embodiments is an advertising system with a computer assembly (5) screen (2) in which the advertisements are broadcast to a person who passes by the advertisement assembly (1) and is detected with the sensors. The image of the person is captured by least one camera (4) and his/her voice is received by a microphone (6) to transmit this data to the system for analyzing the person's mood, gender, age, facial lines, hair color.

In addition to the existing features, a microphone (6) is placed on the display (2) so that the display (2) can understand voice commands. Thus, the sound detected by the microphone (6) is transmitted to the computer assembly (5). The computer assembly (5) evaluates the sound it detects and selects content accordingly to transmit the image to the display (2).

In a different embodiment of the invention, a questionnaire can be conducted via questions displayed to the user on the display (2). Responses to the questionnaire can be transmitted to the computer assembly (5) via the microphone (6) and the results can be evaluated and reported on the computer assembly (5).

With some embodiments of the invention, the number of visitors and how much time the visitors spend at certain points can be determined. For example, with the sensors (3) of the display (2) positioned in a shop, the number of people passing by the display (2) and the duration of their stay in the shop on average can be determined. In another example, it can be reported how long the spa area is being used by placing a display (2) to a hotel spa.

In a further function, which can be provided by embodiments of the invention, the displays (2) can be used to navigate indoors in large venues such as shopping malls, hospitals, etc., since they can determine the location of the customers. For this purpose, in the advertisement system of embodiments of the invention (1), NFC, Bluetooth and Wi-Fi is used for navigation in the interior areas. In the advertising assemblies (1) installed in the outdoor areas, the GPRS is used to locate the position of a person and transmit it to the computer assembly (5).

The invention in embodiments is an advertising assembly (1) having a display (2) on which advertisement broadcasts are made, with its sensors (3) detecting the person in front of the advertisement system, the camera (4) capturing the image of the person, the microphone (6) receiving the voice and a computer assembly (5) which evaluates the transmitted data from the camera and microphone and reflects the figure matching the result of the evaluation on the display (2).

1. An advertising system, comprising:
a display which advertisement broadcasts are made;
sensors configured to detect a person in front of an advertisement assembly;
a camera configured to capture an image of the person in front of the advertisement assembly;
a microphone configured to receive voice commands of the person in front of the advertisement assembly;
a computer assembly which evaluates transmitted data from the camera and microphone and reflects a figure matching a result of the evaluation on the display.

2. An advertisement system according to claim 1, further comprising at least one of NFC, Bluetooth and Wi-Fi for determining a location of the person in front of the advertisement assembly for navigation in interior locations.

3. An advertisement system according to claim 1, further comprising a GPRS system which locates a person in outdoor areas and transmits the person's location to the computer assembly.
